(19) United States
(12) Patent Application Publication
(10) Pub. No.: US 2017/0241335 A1
(43) Pub. Date: Aug. 24, 2017

(54) CARBON REMOVING AND CLEANING DEVICE AND METHOD FOR ENGINE FUEL NOZZLE AND COMBUSTION CHAMBER OF AUTOMOBILE

(71) Applicant: XINYU LIU, BEIJING (CN)

(72) Inventor: XINYU LIU, BEIJING (CN)

(21) Appl. No.: 15/502,989

(22) PCT Filed: Jun. 23, 2016
(86) PCT No.: PCT/CN2016/086857

§ 371 Date: Feb. 9, 2017

(30) Foreign Application Priority Data
Oct. 9, 2015 (CN) 2015207790947

(51) Int. Cl. F02B 77/04; F02M 65/00

(52) U.S. Cl. CPC F02B 77/04; F02M 65/008

(57) ABSTRACT

The present invention discloses a carbon removing and cleaning device and method for an engine fuel nozzle and a combustion chamber of an automobile. The carbon removing and cleaning device comprises a fuel supply pipeline provided with a quick joint and a fuel line connection arranged in the front of the engine fuel nozzle; and a tee joint is connected between the quick joint and the fuel line connection, the quick joint is connected with a first inlet of the tee joint, an outlet of the tee joint is connected with the fuel line connection, a second inlet of the tee joint is connected with a pressurized cleaning agent tank, an electric control cleaning agent nozzle is arranged between the second inlet and a connecting port of the cleaning agent tank, and the pressure of a cleaning agent in the cleaning agent tank is larger than the fuel supply pressure of a fuel supply pipeline. The carbon removing and cleaning device is simple in structure, the cleaning agent can be directly mixed into fuel through a tee additionally arranged in a fuel delivery pipeline, and dynamic mixing ratio control can be performed by virtue of the electric control cleaning agent nozzle, so that a satisfied cleaning effect for the fuel nozzle and the top of a piston is achieved under the conditions that the stable idling operation of the engine is maintained, a proper amount of cleaning agent is input and the cleaning time is reasonable.

### TECHNICAL FIELD

The present invention belongs to automobile engine maintaining and cleaning and relates to a carbon removing and cleaning device and method for an engine fuel nozzle and a combustion chamber of an automobile, which is particularly suitable for a direct injection engine and is capable of realizing the application a non-dangerous cleaning agent for the fuel nozzle to carbon removing and cleaning of the engine fuel nozzle and the combustion chamber of the automobile.

### BACKGROUND ART

Cleaning the engine fuel nozzle of the automobile is performed by using cleaning agents for the fuel nozzle when an engine of the automobile idles, the traditional cleaning is performed by using solvent-based cleaning agents with heat values, and the normal idling operation of the engine is enabled by using the cleaning agents instead of fuel. Because having certain heat values, the cleaning agents are combustible chemicals, i.e., a dangerous chemicals and bring risks in product production, storage and usage. The cleaning agents have very nonideal effects on cleaning carbon deposits in the combustion chamber and particularly carbon deposits at the top of a piston, and because of being hard carbon deposits, the carbon deposits at the top of the piston cannot be effectively cleaned by using the solvent-based cleaning agents. There is another method that the fuel nozzle is dismounted to clean in a 4S shop, which is very troublesome, low in efficiency and long in time; and a method realized through dismounting a spark plug, injecting the cleaning agents from a gap of the spark plug to the inside of a tank and removing the carbon deposits at the top of the piston by using a soaking method wastes time and energy, engine oil needs to be replaced in time after cleaning is finished because most of the cleaning agents are water-based alkaline cleaning agents, at present, a novel engine is an in-cylinder direct injection engine which is very sensitive to carbon deposits in the fuel nozzle and at the top of the piston, so that the carbon deposits in the fuel nozzle and at the top of the piston need to be cleaned periodically. Meanwhile, a lubricating oil film on the cylinder wall of the direct injection engine can be damaged by the solvent-based cleaning agents for the fuel nozzle, and therefore, the solvent-based cleaning agents are not suitable for cleaning the fuel nozzle of the direct injection engine; The traditional method for cleaning the carbon deposits at the top of the piston can also damage the lubricating oil film on the cylinder wall so as not to be beneficial to the direct injection engine. Therefore, it would be highly desirable for directly cleaning under an operating state of the engine.

### SUMMARY OF THE INVENTION

The present invention aims at providing a carbon removing and cleaning device and method for an engine fuel nozzle and a combustion chamber of an automobile, which is particularly suitable for a direct injection engine, can be used for removing carbon deposits in the fuel nozzle and also cleaning carbon deposits at the top of a piston in one operation and cannot damage an oil film on a cylinder wall. A cleaning agent is dynamically mixed into fuel under the state that the direct injection engine is kept in idling operation, the application of a non-dangerous cleaning agent for the fuel nozzle to carbon removing and cleaning of the engine fuel nozzle and the combustion chamber is realized, and fire hazards of the cleaning agent in storage, transportation and usage are also avoided.

In order to achieve the aims, the technical solution is as follows:

A carbon removing and cleaning device for an engine fuel nozzle and a combustion chamber of an automobile, comprising an engine, a fuel supply pipeline provided with a quick joint is connected with a fuel line connection arranged in the front of the engine fuel nozzle; a tee joint is arranged between the quick joint and the fuel line connection, the quick joint is connected with a first inlet of the tee joint, and an outlet of the tee joint is connected with the fuel line connection, a second inlet of the tee joint is connected with a pressurized cleaning agent tank, an electric control cleaning agent nozzle is arranged between the second inlet and a connecting port of the cleaning agent tank, a cleaning agent pulse setting circuit is connected with the electric control cleaning agent nozzle, and the pressure of a cleaning agent output from the cleaning agent tank is larger than the fuel supply pressure of a fuel supply pipeline.

The scheme is further as follows: a pipeline connected with the cleaning agent tank is provided with a first pressure regulating valve for stabilizing the pressure of the cleaning agent in the front of the electric control cleaning agent nozzle to further ensure that the cleaning agent is stably mixed with fuel.

The scheme is further as follows: the pressure of the cleaning agent is 1-1.5 kg/cm² larger than the fuel supply pressure of the fuel supply pipeline.

The scheme is further as follows: the cleaning agent in the cleaning agent tank is an organic carbon removing agent, the pressure of the cleaning agent is 1.5 kg/cm² larger than the fuel supply pressure of the fuel supply pipeline, the injection quantity of the cleaning agent is 7.5 ml/min, and the pulse setting frequency is 20 Hz.

The scheme is further as follows: the first pressure regulating valve is arranged on the pipeline for connecting the cleaning agent tank and the electric control cleaning agent nozzle, or the first pressure regulating valve can be arranged in the middle of a pipeline for connecting an air booster pump and the cleaning agent tank when the cleaning agent tank is connected with the air booster pump.

The scheme is further as follows: the quick joint is connected into the tee joint through a second pressure regulating valve.

A carbon removing and cleaning control method for an engine fuel nozzle and a combustion chamber of an automobile, comprising a preparation step and a cleaning step,

the preparation step is as follows: stopping an engine, disconnecting a fuel line connection in the front of an engine fuel nozzle, connecting an output port of a tee joint into the fuel line connection, and communicating the output port with an engine fuel nozzle, connecting one input port of the tee joint with a second pressure regulating valve, connecting an input port of the second pressure regulating valve with a disconnected fuel line supply pipe orifice connected with the fuel line connection, connecting the other input port of the tee joint with an electric control cleaning agent nozzle, connecting a liquid inlet of the electric control cleaning agent nozzle with an outlet of a first pressure regulating valve, connecting an input port of the first pressure regulating valve with a pressurized cleaning agent tank, setting a controlled pulse frequency value, cleaning time value and total cleaning agent injection quantity value within set cleaning time of the electric control cleaning agent nozzle, and calculating the cleaning agent injection quantity per second according to the pulse frequency value, cleaning time value and total cleaning agent injection quantity value;

and the cleaning step is as follows: starting the engine, enabling the engine to be in an idling state, regulating the first pressure regulating valve and the second pressure regulating valve to ensure that the pressure of the cleaning agent is 1-1.5 kg/cm² larger than the fuel supply pressure of a fuel supply pipeline, starting cleaning and recording time when the pressure is stable, regulating the pulse width according to the calculated cleaning agent injection quantity per second, and finishing cleaning until reaching to the cleaning time.

The scheme is further as follows: the cleaning agent in the cleaning agent tank is an organic carbon removing agent.

The scheme is further as follows: the pressure of the cleaning agent is 1.5 kg/cm² larger than the fuel supply pressure of the fuel supply pipeline, the cleaning time is 40 min, the controlled pulse frequency value is 20 Hz, and the total cleaning agent injection quantity value is 300 ml.

The scheme is further as follows: the method characterized by further comprising a step of also disposing the first pressure regulating valve between an air booster pump and the cleaning agent tank when the cleaning agent tank is connected with the air booster pump.

The carbon removing and cleaning device has the beneficial effects that the structure is simple, the cleaning agent can be directly mixed into the fuel through the tee joint additionally arranged in the fuel delivery pipeline, and the dynamic mixing ratio control can be performed by virtue of the the electric control cleaning agent nozzle, a satisfied cleaning effect for the fuel nozzle and the top of the piston is achieved under the conditions that the stable idling operation of the engine is maintained, the proper amount of cleaning agent is input and the cleaning time is reasonable, the cleaning agent mixed with the fuel is enabled to clean carbon deposits and colloids when passing through the the fuel nozzle and the top of the piston, and therefore, the aim of simultaneously removing carbon deposits in the fuel nozzle and at the top of the piston by using the novel cleaning agent once is achieved, the problem of carbon deposition in the fuel nozzle of the direct injection engine and at the top of the piston is very conveniently solved, a great number of manpower and labor hours are saved, and the revolution on a method for maintaining the direct injection engine is brought. The aim of applying the non-dangerous cleaning agent for the fuel nozzle to cleaning of the engine fuel nozzle and combustion chamber of the automobile is achieved, the cleaning effect is improved, particularly, the problem that the traditional cleaning agent for the fuel nozzle is combustible and dangerous is solved, and risks of the cleaning agent in storage, transportation and usage are avoided.

Drawings diagram of a device for determining a user relationship provided by an embodiment 3 of the present application.

### BRIEF DESCRIPTION OF THE DRAWINGS

FIG. 1 is a schematic structure diagram of the carbon removing and cleaning device for the engine fuel nozzle and the combustion chamber of the automobile;

FIG. 2 is a logic schematic diagram of a pulse setting circuit of the carbon removing and cleaning device for the engine fuel nozzle and the combustion chamber of the automobile.

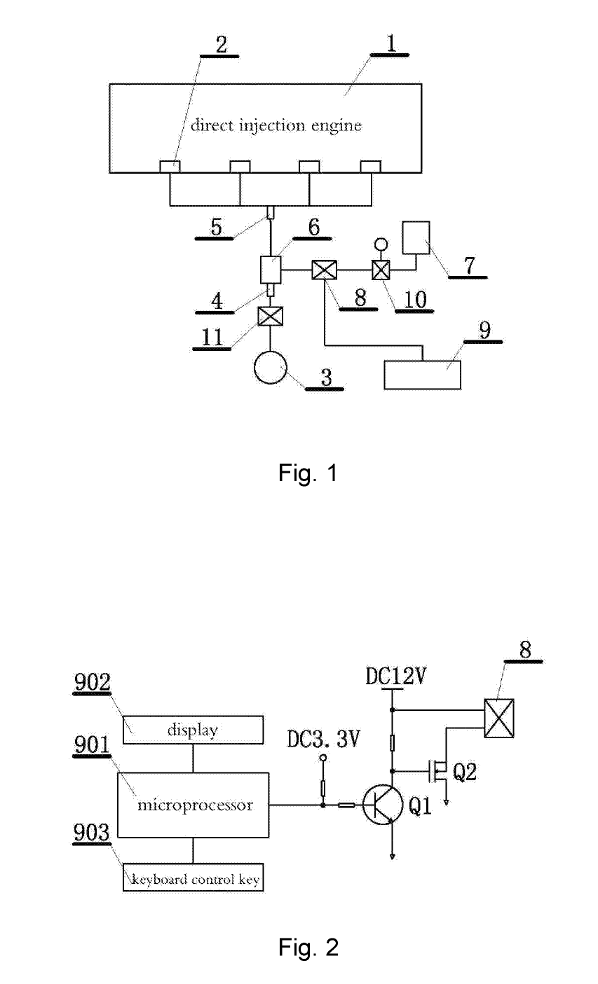

### DETAILED DESCRIPTION OF THE INVENTION

### Example 1

A carbon removing and cleaning device for an engine fuel nozzle and a combustion chamber of an automobile, being particularly suitable for a direct injection engine and comprising an engine 1 of an automobile and a fuel nozzle 2 provided with a supply cylinder and arranged on the engine, the fuel supply of the fuel nozzle is realized in a way that a fuel supply pipeline provided with a quick joint 4 is connected with a fuel line connection 5 arranged in the front of the engine fuel nozzle after fuel is pumped from a fuel tank by using a fuel pump 3, wherein when the engine fuel nozzle needs to be cleaned, a tee joint 6 is connected between the quick joint and the fuel line connection, a first inlet of the tee joint is provided with a buckle same as the fuel line connection so as to be connected with the quick joint, the quick joint is connected with the first inlet of the tee joint, an outlet of the tee joint is connected and provided with the quick joint same as the fuel supply pipeline, the quick joint passing through a tee is connected with the fuel line connection, a second inlet of the tee joint is connected with a pressurized cleaning agent tank 7, an electric control cleaning agent nozzle 8 is arranged between the second inlet and a connecting port of the cleaning agent tank, a cleaning agent pulse setting circuit 9 is connected with the electric control cleaning agent nozzle, and the pressure of a cleaning agent in the cleaning agent tank is larger than the fuel supply pressure of the fuel supply pipeline.

In the example, a first pressure regulating valve 10 is arranged between the electric control cleaning agent nozzle and the connecting port of the cleaning agent tank, is provided with a pressure gauge and is used for stabilizing the pressure of the cleaning agent in the front of the connecting port of the electric control cleaning agent nozzle, and furthermore, the cleaning agent is kept stably mixed with the fuel. If the pressure of the cleaning agent is lower than that of an engine fuel pipe, the cleaning agent cannot be input to the engine; conversely, if the pressure of the cleaning agent is far higher than that of an engine fuel pipe, the cleaning agent can be quickly input to the engine to result in failure that the cleaning agent is reasonably mixed with the fuel, the excessive cleaning agent is mixed into the fuel to result in failure of stable idling operation of the direct injection engine, and thus, a stable cleaning process cannot be established, and a proper greater range or a greater point for a certain cleaning agent and the usage amount of the cleaning agent is especially important.

Therefore, the pressure of the cleaning agent is 1-1.5 kg/cm² larger than the fuel supply pressure of the fuel supply pipeline.

A preferred solution is as follows: the cleaning agent in the cleaning agent tank is an organic carbon removing agent, the pressure of the cleaning agent is 1.5 kg/cm² larger than the fuel supply pressure of the fuel supply pipeline, the injection quantity of the cleaning agent is 7.5 ml/min, and the pulse setting frequency is 20 Hz.

The pressure of the cleaning agent in the cleaning agent tank can be filled and self-provided in the tank in advance, which is generally achieved through an air booster, the general pressure is 6 kg/cm² or below, while the general pressure of the fuel supply pipeline is 4.5-5 kg/cm², the fuel pressure of the fuel supply pipeline needs to be regulated and matched in order to ensure the pressure difference range of 1-1.5 kg/cm², and therefore, the quick joint is connected into the tee joint through a second pressure regulating valve 11; for a connection way, the first pressure regulating valve is arranged on a pipeline for connecting the cleaning agent tank and the electric control cleaning agent nozzle, or the first pressure regulating valve can be arranged in the middle of a pipeline for connecting an air booster pump and the cleaning agent tank when the cleaning agent tank is connected with the air booster pump.

The pulse setting circuit is as shown in FIG. 2 and comprises a microprocessor 901, a display 902 and a keyboard control key 903 are connected around the microprocessor, a control program of the electric control cleaning agent nozzle is put into a memory of the microprocessor, the control program realizes control on the electric control cleaning agent nozzle by virtue of a driving circuit, the driving circuit comprises a driving switch transistor Q1 and a switching field-effect transistor Q2, a control base of the driving switch transistor Q1 is controlled by the microprocessor, an output of the driving switch transistor Q1 controls the switching of the switching field-effect transistor Q2, and an output of the switching field-effect transistor Q2 is connected with the electric control cleaning agent nozzle, so that the circuit is simple and reliable.

### Example 2

A control method based on the carbon removing and cleaning device for the engine fuel nozzle and the combustion chamber of the automobile in example 1, therefore, the content in example 1 should be used as the content in example 2, the method comprises a preparation step and a cleaning step, wherein

the preparation step is as follows: stopping an engine, disconnecting a fuel line connection in the front of an engine fuel nozzle, connecting an output port of a tee joint into the fuel line connection, and communicating the output port with an engine fuel nozzle, connecting one input port of the tee joint with a second pressure regulating valve, connecting an input port of the second pressure regulating valve with a disconnected fuel line supply pipe orifice connected with the fuel line connection, connecting the other input port of the tee joint with an electric control cleaning agent nozzle, connecting a liquid inlet of the electric control cleaning agent nozzle with an outlet of a first pressure regulating valve, connecting an input port of the first pressure regulating valve with a pressurized cleaning agent tank, setting a controlled pulse frequency value, cleaning time value and total cleaning agent injection quantity value within set cleaning time of the electric control cleaning agent nozzle, and calculating the cleaning agent injection quantity per second according to the pulse frequency value, cleaning time value and total cleaning agent injection quantity value;

and the cleaning step is as follows: starting the engine, enabling the engine to be in an idling state, regulating the first pressure regulating valve and the second pressure regulating valve to ensure that the pressure of the cleaning agent is 1-1.5 kg/cm² larger than the fuel supply pressure of a fuel supply pipeline, starting cleaning and recording time when the pressure is stable, regulating the pulse width according to the calculated cleaning agent injection quantity per second, and finishing cleaning until reaching to the cleaning time.

The cleaning agent in the cleaning agent tank is an organic carbon removing agent, i.e., a cleaning agent ZG7100 produced by American Lubrizol Corporation, is a non-solvent-based organic carbon removing agent and not only can be used for removing carbon deposits in the fuel nozzle and at the top of a piston in one operation, but also cannot damage an oil film on a cylinder wall so as to be a non-dangerous cleaning agent. When the organic carbon removing agent is used, the cleaning effect is excellent under the parameters that the pressure of the cleaning agent is 1.5 kg/cm² larger than the fuel supply pressure of the fuel supply pipeline, the length value of the cleaning time is 40 min, the controlled pulse frequency value is 20 Hz, and the total cleaning agent injection quantity value is 300 ml.

The method further comprises a step of also disposing the first pressure regulating valve between an air booster pump and the cleaning agent tank when the cleaning agent tank is connected with the air booster pump.

According to the example, the control method has the technical advantages that the advanced cleaning agent is dynamically mixed with the fuel in the fuel pipe of the direct injection engine, the cleaning agent is introduced to the engine by the fuel, the idling operation of the engine is maintained by the fuel, the carbon deposits in the fuel nozzle and at the top of the piston are removed by using the cleaning agent, and then, the cleaning agent and the decomposed carbon deposits are mixed with the fuel to burn so as to be discharged out of the engine. The application of the non-dangerous cleaning agent to cleaning of the engine fuel nozzle and the combustion chamber of the automobile is realized. Therefore, using the traditional combustible cleaning agent for the fuel nozzle is avoided, cleaning the fuel nozzle by using dangerous chemicals is also avoided, and risks brought by the chemicals in product production, storage, transportation and usage are eliminated.

1. A carbon removing and cleaning device for an engine fuel nozzle and a combustion chamber of an automobile, comprising an engine, a fuel supply pipeline provided with a quick joint is connected with a fuel line connection arranged in the front of the engine fuel nozzle; characterized in that a tee joint is arranged between the quick joint and the fuel line connection, the quick joint is connected with a first inlet of the tee joint, and an outlet of the tee joint is connected with the fuel line connection, a second inlet of the tee joint is connected with a pressurized cleaning agent tank, an electric control cleaning agent nozzle is arranged between the second inlet and a connecting port of the cleaning agent tank, a cleaning agent pulse setting circuit is connected with the electric control cleaning agent nozzle, and the pressure of a cleaning agent output from the cleaning agent tank is larger than the fuel supply pressure of a fuel supply pipeline.

2. The carbon removing and cleaning device of claim 1, characterized in that a pipeline connected with the cleaning agent tank is provided with a first pressure regulating valve for stabilizing the pressure of the cleaning agent in the front of the electric control cleaning agent nozzle to further ensure that the cleaning agent is stably mixed with fuel.

3. The carbon removing and cleaning device of claim 1, characterized in that the pressure of the cleaning agent is 1-1.5 kg/cm² larger than the fuel supply pressure of the fuel supply pipeline.

4. The carbon removing and cleaning device of claim 1, characterized in that the cleaning agent in the cleaning agent tank is an organic carbon removing agent, the pressure of the cleaning agent is 1.5 kg/cm² larger than the fuel supply pressure of the fuel supply pipeline, the injection quantity of the cleaning agent is 7.5 ml/min, and the pulse setting frequency is 20 Hz.

5. The carbon removing and cleaning device of claim 2, characterized in that the first pressure regulating valve is arranged on the pipeline for connecting the cleaning agent tank and the electric control cleaning agent nozzle, or the first pressure regulating valve can be arranged in the middle of a pipeline for connecting an air booster pump and the cleaning agent tank when the cleaning agent tank is connected with the air booster pump.

6. The carbon removing and cleaning device of claim 1, characterized in that the quick joint is connected into the tee joint through a second pressure regulating valve.

7. A carbon removing and cleaning control method for an engine fuel nozzle and a combustion chamber of an automobile, comprising a preparation step and a cleaning step, and characterized in that
the preparation step is as follows: stopping an engine, disconnecting a fuel line connection in the front of an engine fuel nozzle, connecting an output port of a tee joint into the fuel line connection, and communicating the output port with an engine fuel nozzle, connecting one input port of the tee joint with a second pressure regulating valve, connecting an input port of the second pressure regulating valve with a disconnected fuel line supply pipe orifice connected with the fuel line connection, connecting the other input port of the tee joint with an electric control cleaning agent nozzle, connecting a liquid inlet of the electric control cleaning agent nozzle with an outlet of a first pressure regulating valve, connecting an input port of the first pressure regulating valve with a pressurized cleaning agent tank, setting a controlled pulse frequency value, cleaning time value and total cleaning agent injection quantity value within set cleaning time of the electric control cleaning agent nozzle, and calculating the cleaning agent injection quantity per second according to the pulse frequency value, cleaning time value and total cleaning agent injection quantity value;
and the cleaning step is as follows: starting the engine, enabling the engine to be in an idling state, regulating the first pressure regulating valve and the second pressure regulating valve to ensure that the pressure of the cleaning agent is 1-1.5 kg/cm² larger than the fuel supply pressure of a fuel supply pipeline, starting cleaning and recording time when the pressure is stable, regulating the pulse width according to the calculated cleaning agent injection quantity per second, and finishing cleaning until reaching to the cleaning time.

8. The method of claim 7, characterized in that the cleaning agent in the cleaning agent tank is an organic carbon removing agent.

9. The method of claim 8, characterized in that the pressure of the cleaning agent is 1.5 kg/cm² larger than the fuel supply pressure of the fuel supply pipeline, the cleaning time is 40 min, the controlled pulse frequency value is 20 Hz, and the total cleaning agent injection quantity value is 300 ml.

10. The method of claim 7, characterized by further comprising a step of also disposing the first pressure regulating valve between an air booster pump and the cleaning agent tank when the cleaning agent tank is connected with the air booster pump.

11. The carbon removing and cleaning device of claim 2, characterized in that the cleaning agent in the cleaning agent tank is an organic carbon removing agent, the pressure of the cleaning agent is 1.5 kg/cm² larger than the fuel supply pressure of the fuel supply pipeline, the injection quantity of the cleaning agent is 7.5 ml/min, and the pulse setting frequency is 20 Hz.

12. The carbon removing and cleaning device of claim 3, characterized in that the cleaning agent in the cleaning agent tank is an organic carbon removing agent, the pressure of the cleaning agent is 1.5 kg/cm² larger than the fuel supply pressure of the fuel supply pipeline, the injection quantity of the cleaning agent is 7.5 ml/min, and the pulse setting frequency is 20 Hz.
